(19) United States
(12) Patent Application Publication
(10) Pub. No.: US 2004/0155786 A1
(43) Pub. Date: Aug. 12, 2004

(54) Method and tool for installing a linear smoke detector

(76) Inventors: Heinz Guttinger, Oetwil Am See (CH); Johann Gysin, Zumikon (CH)

Correspondence Address: BAKER & BOTTS, 30 ROCKEFELLER PLAZA, NEW YORK, NY, 10112

(21) Appl. No.: 10/764,623

(22) Filed: Jan. 26, 2004

(30) Foreign Application Priority Data
Jan. 29, 2003 (EP) 03 001 851.9

(51) Int. Cl. G08B 17/10

(52) U.S. Cl. 340/630; 340/693.5

(57) ABSTRACT

A linear smoke detector having a light emitter (1) and a light receiver (2), and a reflector (4) which is arranged opposite the detector (D). The light emitter (1) emits a light beam to the reflector (4), which reflects it onto the light receiver (2). Wherein the installation of the smoke detector is effected by an installation tool with a light source aimed in the same direction as the light emitter (1) is placed over the detector (D) and emits bundled light. The installation position of the reflector is marked by a point of the bundled light on a surface opposite the installation tool. Further, the installation tool is an installation cover (8) which can be placed on the front of the detector (D), with a built-in laser (9), the light beam of which essentially coincides with that of the light emitter (1).

This invention relates to a method of installing or commissioning a linear smoke detector, which has an emitter/receiver part, called a detector, with a light emitter and a light receiver, and a reflector which is arranged opposite the detector. The light emitter emits a light beam to the reflector, which in turn reflects the light beam to the light receiver.

### BACKGROUND OF THE INVENTION

Smoke detectors as generally described above are also called line extinction detectors, and are used in particular in large or narrow spaces, for instance in corridors, storage and manufacture halls and aircraft hangars. Such detectors are generally mounted on a wall below the ceiling. In the standard installation, the emitter and receiver are opposite each other, and no reflector is required. For many years, these have been used only if the spaces have dimensions that a minimum light beam length of about 10 m would otherwise not be reached; or where the wall side opposite the emitter is unstable; or where no receiver can be installed. However, since an installation with a reflector is more economical and significantly simpler to install, the linear smoke detector with a reflector is today being used more frequently.

The installation and commission of a linear smoke detector requires that the optical system must be precisely aligned. The alignment of the optical system onto the reflector represents the most difficult step of installation and commissioning, and is also very costly, because it requires the co-operation of two people. One person operates the detector, and the other person positions the reflector so that the output signal of the electronics of the light receiver is optimized. Obviously, the reflector can be mounted first and the detector can then be aligned relative to it, but this does not diminish the labor intensiveness and cost of installation. Today, there are also linear smoke detectors having a special adjustment set, e.g., a kind of target device which is clamped to the detector and used to align it with a previously mounted reflector.

### SUMMARY OF THE INVENTION

The present invention is intended to provide a novel method of installing or commissioning a linear smoke detector using a tool specially adapted for carrying out this method which considerably reduces and simplifies the labor and cost of installation. The method according to the present invention requires either that the detector is mounted first and then the installation tool is put onto the emitter/receiver detector part, and the mounting position for the reflector is marked, and then the reflector is mounted; or that the reflector is mounted first and then the detector, and thereafter the detector is aligned with the reflector using the installation tool. In accordance with the present invention, the installation and commissioning operations are simple and only require one person.

As discussed above, the present invention includes a tool for carrying out the installation, for example, an installation cover which contains a laser and is used to replace the original cover on the detector during installation. A laser which is horizontally and vertically aligned and incorporated into the installation cover is aligned and aimed in the same direction as the detector which is adjusted in the factory.

### BRIEF DESCRIPTION OF THE DRAWINGS

The present invention is disclosed in greater detail below in conjunction with a preferred embodiment and the drawings in which:

FIG. 1 illustrates a block diagram of a linear smoke detector; and

FIG. 2 illustrates a schematic representation of the emitter/receiver part of a linear smoke detector with a novel tool in accordance with the present invention.

### DETAILED DESCRIPTION OF THE INVENTION

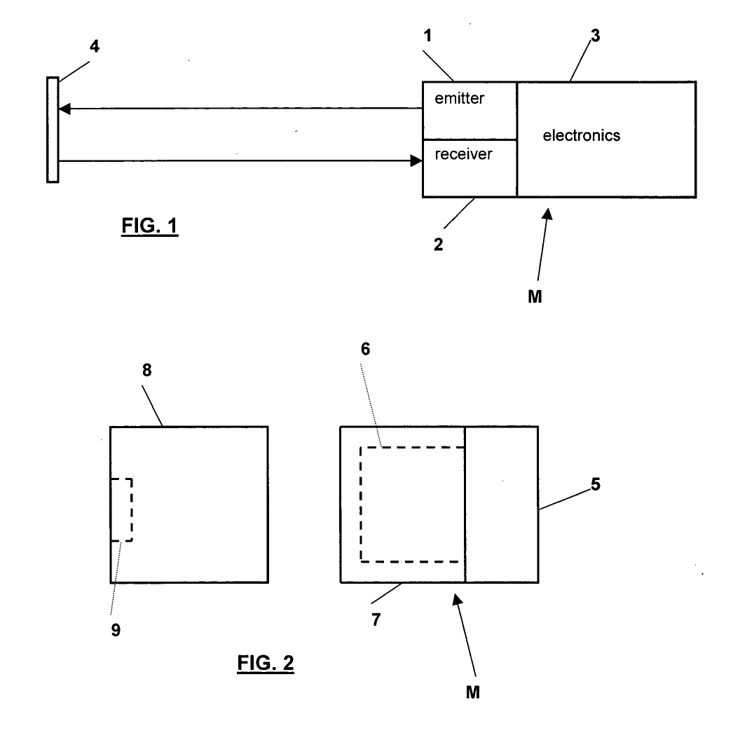

The smoke detector shown in FIG. 1 functions on the extinction principle, i.e., the weakening of a light beam by smoke entering the detector. As shown, the smoke detector comprises an emitter/receiver part, called the detector D. In the detector D a light receiver 2 which is arranged next to the light emitter 1 and further comprises microprocessor-controlled control, analysis electronics 3, and a separate reflector 4 located opposite the detector D. The detector D is adjusted in the factory so that the light beam which the light emitter emits is horizontally and vertically aligned.

The light emitter 1 emits a modulated infra-red beam to the reflector 4, which in turn reflects the beam which impinges on it onto the light receiver 2. As soon as smoke particles enter the path of the beam, a part of the infra-red beam is absorbed by these particles, and another part of the infra-red beam is reflected or scattered by the particles. These effects cause a diminution or weakening of the light which impinges on the light receiver 2 and result in a potential alarm condition. The light emitter 1 and light receiver 2, together with the electronics 3, form the detector insert 6 as illustrated in FIG. 2.

The reflector 4 is, for example, a retroreflecting prism in the shape of a straight pyramid, the side faces of which are in the form of isosceles right-angled triangles. Such a reflector acts as a polarizer on the impinging light, and rotates its plane of polarization by about 90°, which angle is capable of scattering in a certain range.

The smoke detector of the present invention is used in particular to monitor large storage and manufacture halls, spaces with complex ceiling constructions or art-historically valuable ceilings, rooflined inner courts, atrium buildings or reception halls, where the distance between the emitter/receiver part D and the reflector 4 may be between 5 and 100 m, and in exceptional cases even more than 100 m.

The detector D illustrated in FIG. 2 consists of the detector insert 6 which is fixed in a base 5, with the whole optical and electronic system, part of which can be in the base 5, and a cover 7, which is used to cover the detector insert 6. The cover 7 is substantially a daylight filter. It is put over the mounted, adjusted detector insert 6 and fixed by bolts (not shown). The base 5 is, for example, in an adjustable form, so that the inclination of the detector D and thus the axis of the light beam which the light emitter 1 emits is adjustable. This kind of adjustment of the detector D is referred to as a coarse adjustment. Additionally, in or on the detector D, means are provided for aligning the optical system of the light emitter 1 and light receiver 2. Aligning the optical system using these means is referred to as a fine adjustment.

The installation or commission of the emitter/receiver part D requires the detector cover 7 to be removed and replaced with a tool for mutual alignment of the detector D and reflector 4. As shown in FIG. 2, this tool is a separator installation cover 8 with a light source, preferably in the form of a laser 9, which emits bundled light. The laser 9 is mounted on or in the installation cover 8, in such a way that it is aligned with the light emitter 1 (FIG. 1) of the detector D, and thus is “aimed” in the same direction as the light emitter 1. Obviously, the laser 9 must not interfere with the light beam of the light emitter 1. Power is supplied to the laser 9 either via the detector base 5 from the mains or from a battery which is in the installation cover 8.

The light beam which the laser 9 emits marks the place at which the light beam which the light emitter 1 emits impinges on the wall opposite the detector D, and thus the place at which the reflector 4 (FIG. 1) must be mounted.

The linear smoke detector can be installed/commissioned in the following ways:

The detector D is mounted in the base 5, and the reflector 4 is not yet mounted. In this case, the laser beam of the laser 9 marks, on the opposite wall, the place where the reflector 4 must be mounted. In the detector D, only fine adjustment is still necessary.

The mounting position of the reflector 4 is defined, for instance the reflector 4 is already mounted, and the detector D must be aligned with the reflector 4. In this case the detector D, with the installation cover 8 on it, is moved over the wall until the laser beam impinges on the reflector 4 or its mounting position, so that the mounting position of the detector D can be marked and then the detector D can be mounted. After mounting, only fine adjustment to the detector D is necessary. The precondition of this method of installation is as smooth a wall as possible.

The mounting positions of both the reflector 4 and the detector D are defined, the latter because the base 5 is already mounted. The laser beam of the laser 9 supplies a starting point for how large the deviation between the detector D and reflector 4 is, and makes the coarse adjustment of the detector D easier. It is also possible to measure this deviation, to read an adjustment magnitude from a table on the basis of the deviation and the distance between the detector D and reflector 4, and to adjust an adjustment device, which is provided on the detector, accordingly. In both cases, only fine adjustment is still necessary.

The mounting positions of both the reflector 4 and the detector D are defined. The base 5 is adjustable. The laser point is positioned with the adjustable base 5 so that it impinges on the reflector 4. On the detector D, only fine adjustment is still necessary.

After installation, the installation cover 8 is removed from the detector D and replaced by the detector cover 7, so that the linear smoke detector is ready for operation.

The installation cover tool 8 is also helpful with application problems. If such problems (e.g., building deformation, vibration, undefined covering of the light beam, etc.) occur, the installation cover 8 is mounted and the laser point is observed in critical phases. In this way a possible application problem can be confirmed or excluded.

We claim:

1. A method of installing a linear smoke detector having a light emitter and a light receiver, together referred to as the detector, and a reflector which is arranged opposite the detector and which reflects a light beam from the light emitter to the light receiver, said method comprising fixing the detector at an installation position, affixing an installation tool comprising a light source which is aimed in the same direction as the light emitter onto the detector, actuating the light source so as to emit bundled light marking the installation position of the reflector using the bundled light emitted from the light source, and installing the reflector at the installation position.

2. A method of installing a linear smoke detector having a light emitter and a light receiver, together referred to as a detector, and a reflector which is arranged opposite the detector and which reflects a light beam from the light emitter to the light receiver, said method comprising mounting the reflector at an installation position, affixing an installation tool comprising a light source which is aimed in the same direction as the light emitter onto the detector, actuating the light source so as to emit bundled light, aligning the detector with the reflector using a position of the bundled light emitted on a surface opposite the reflector, thereby determining a mounting position of the detector, and installing the detector at said position.

3. The method according to claim 1, wherein after the reflector is mounted, making a fine adjustment of an optical system for the light emitter and light receiver.

4. The method according to claim 2, wherein the detector and reflector are mounted at a mounting position, and the installation tool is put on the detector and the detector is aligned relative to the reflector by changing the detector's inclination.

5. The method according to claim 4, wherein the detector is aligned on the basis of an adjustment magnitude which is determined by a magnitude of deviation of a point of light from the reflector and a distance between the detector and reflector.

6. A tool for aligning a linear smoke detector and reflector, comprising a cover which is adapted to fit on a front side of the detector, said cover comprising a light source which emits a beam of bundled light coincident with a light emitter in the detector.

7. A detector adapted for use with the tool according to claim 6, comprising a base, a detector insert which contains a light emitter and light receiver, and a detector cover which covers the detector insert.

8. The tool according to claim 7, wherein the light source is integrated with the installation cover and is aligned with the light emitter.

9. The detector according to claim 7, wherein the base adjusts the detector's inclination.

10. The method according to claim 1 or 2, further comprising aligning the detector on the basis of an adjustment magnitude, which is determined by a magnitude of a deviation of a point of light from the light source and from the reflector and providing a distance between the detector and reflector.

11. The tool according to claim 7, wherein the light source is a laser.
